(19) United States
(12) Patent Application Publication
(10) Pub. No.: US 2026/0186366 A1
(43) Pub. Date: Jul. 2, 2026

(54) TRANSPARENT DISPLAY APPARATUS

(71) Applicant: AUO Corporation, Hsinchu City (TW)

(72) Inventors: Pin-Wei Ho, Hsinchu City (TW); YuTang Tsai, Hsinchu City (TW); Kun-Cheng Tien, Hsinchu City (TW); Shih-Hsiung Lin, Hsinchu City (TW)

(73) Assignee: AUO Corporation, Hsinchu City (TW)

(21) Appl. No.: 19/226,035

(22) Filed: Jun. 2, 2025

(30) Foreign Application Priority Data
Dec. 31, 2024 (TW) 113151721

(51) Int. Cl. G02F 1/17

(52) U.S. Cl. CPC G02F 1/17

(57) ABSTRACT

A transparent display apparatus includes a transparent substrate, a pixel array, and a first light modulating element. The transparent substrate has display areas and transparent areas. The pixel array is disposed on the transparent substrate and includes pixels and openings. Each of the pixel overlaps with a corresponding display area. Each of the openings overlaps with a corresponding transparent area. The pixels are located between the first light modulating element and the transparent substrate. The first light modulating element includes a first light modulating base and first light modulating pillars. The first light modulating base has light-absorbing particles and openings. The first light modulating pillars are respectively disposed in the openings of the first light modulating base. The first light modulating pillars and the first light modulating base have a refractive index difference.

### CROSS-REFERENCE TO RELATED APPLICATION

This application claims the priority benefit of Taiwan application serial no. 113151721, filed on Dec. 31, 2024. The entirety of the above-mentioned patent application is hereby incorporated by reference herein and made a part of this specification.

### BACKGROUND

### Technical Field

The disclosure relates to a transparent display apparatus.

### Related Art

A transparent display apparatus refers to an apparatus that can provide a transparent display state for the user to see the background behind the apparatus, which is commonly used in display windows, vending machines, etc. The transparent display apparatus has display areas and transparent areas. The display areas may provide a display screen to be viewed by the user, while the transparent areas are in a transparent state allowing the user to see the background behind. Pixels are disposed in the display areas to emit image beams toward the display surface of the transparent display apparatus, thereby displaying images. However, some of the image beams may be reflected back to the inside of the transparent display apparatus at the interface between the display surface and the ambient medium, and then reflected by the internal circuits of the transparent display apparatus, resulting in formation of halation. In addition, some other image beams may be transmitted laterally inside the transparent display apparatus, resulting in edge leakage.

### SUMMARY

The disclosure provides a transparent display apparatus with favorable optical performance.

A transparent display apparatus according to an embodiment of the disclosure includes a transparent substrate, a pixel array, multiple signal lines, and a first light modulating element. The transparent substrate includes multiple display areas and multiple transparent areas. The pixel array is disposed on the transparent substrate. The pixel array includes multiple pixels and multiple openings. The multiple pixels are arranged in an array along a first direction and a second direction. The first direction and the second direction intersect each other, and each of the pixels overlaps with a corresponding one of the display areas. Each of the openings is surrounded by a portion of the multiple pixels, and each of the openings overlaps with a corresponding one of the transparent areas. The multiple signal lines are disposed on the transparent substrate, and are electrically connected to the multiple pixels. The transparent substrate has a first side and a second side opposite to each other. The multiple pixels are disposed on the first side of the transparent substrate. The first light modulating element is disposed on the first side of the transparent substrate. The multiple pixels are located between the first light modulating element and the transparent substrate. The first light modulating element includes a first light modulating base and multiple first light modulating pillars. The first light modulating base includes multiple light-absorbing particles and multiple openings. The multiple first light modulating pillars are separated from each other. Each of the first light modulating pillars allows alight beam to pass through. The multiple first light modulating pillars are respectively disposed in the multiple openings of the first light modulating base. The multiple first light modulating pillars and the first light modulating base have a refractive index difference.

### BRIEF DESCRIPTION OF THE DRAWINGS

FIG. 1 is a cross-sectional view showing the transparent display apparatus 10 according to the first embodiment of the disclosure.

FIG. 2 is a top view showing the transparent display apparatus 10 according to the first embodiment of the disclosure with the internal structure visible.

FIG. 3 is a perspective view showing the first light modulating element according to an embodiment of the disclosure.

FIG. 4 is a cross-sectional view showing the transparent display apparatus 10A according to the second embodiment of the disclosure.

FIG. 5 shows the relationship between the refractive index difference Δn and lateral waveguide light leakage, as well as the relationship between the refractive index difference Δn and back light leakage in the transparent display apparatus 10A of the second embodiment of the disclosure.

FIG. 6 shows the normalized light leakage intensity at various inclination angles in the first direction x with respect to the transparent display apparatus of the comparative example (not shown), the transparent display apparatus 10 of the first embodiment, and the transparent display apparatus 10A of the second embodiment.

FIG. 7 shows the normalized light leakage intensity at various inclination angles in the second direction y with respect to the transparent display apparatus of the comparative example (not shown), the transparent display apparatus 10 of the first embodiment, and the transparent display apparatus 10A of the second embodiment.

### DESCRIPTION OF THE EMBODIMENTS

Exemplary embodiments of the disclosure will be described in detail hereinafter, examples of which are illustrated in the accompanying drawings. Wherever possible, the same reference numerals are used in the drawings and descriptions to represent the same or similar parts.

It should be understood that when an element such as a layer, film, area, or substrate is described as being “on” or “connected to” another element, the element may be directly on or connected to the another element, or there may be intervening elements therebetween. On the other hand, when an element is described as being “directly on” or “directly connected to” another element, no intervening element is present. As used herein, “connection” may refer to physical and/or electrical connection. Furthermore, “electrical connection” or “coupling” may mean that there are other elements between two elements.

The terms “about,” “approximately,” and “substantially” as used herein include the stated value and the average values within an acceptable deviation range for a particular value as determined by those skilled in the art, considering the measurement in question and the particular number of errors associated with the measurement (that is, limitations of the measurement system). For example, “about” may mean being within one or more standard deviations of the stated value, or within ±30%, ±20%, ±10%, or ±5%. Furthermore, in regard to the terms “about,” “approximately,” and “substantially” as used herein, a more acceptable deviation range or standard deviation may be selected according to optical properties, etching properties, or other properties, and it is not necessary to use one standard deviation for all properties.

Unless otherwise defined, all the terms (including technical and scientific terms) used herein have the same meanings as commonly understood by those skilled in the art to which the disclosure belongs. It should also be understood that terms, such as those defined in commonly used dictionaries, are interpreted as having consistent meanings in the related art and in the context of the disclosure, and will not be interpreted in an idealized or overly formal sense unless expressly so defined herein.

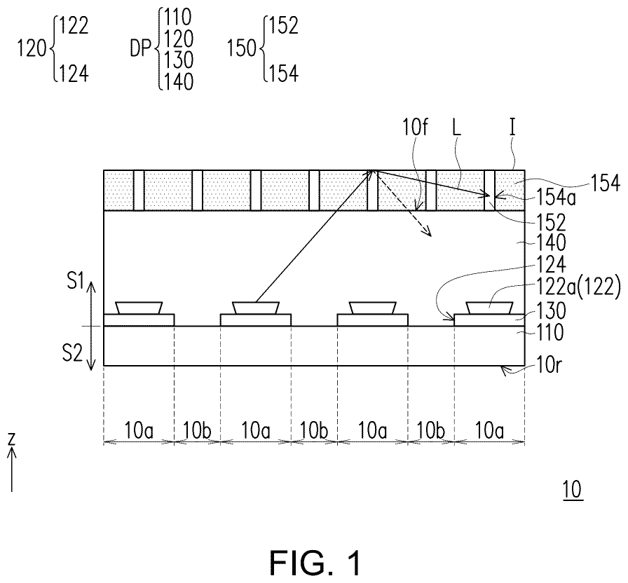

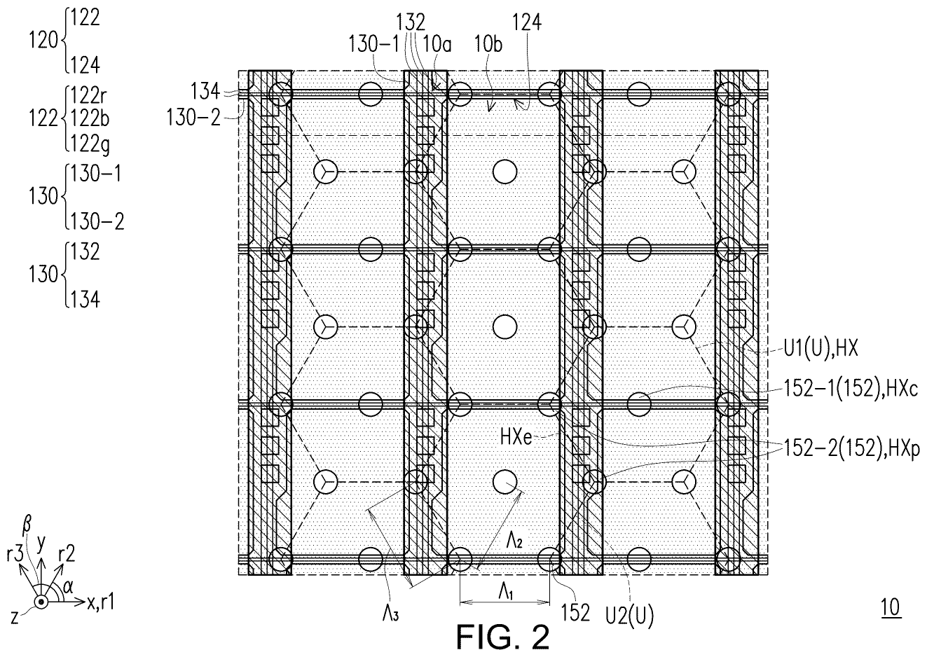

FIG. 1 is a cross-sectional view showing a transparent display apparatus 10 according to the first embodiment of the disclosure. FIG. 2 is a top view showing the transparent display apparatus 10 according to the first embodiment of the disclosure with the internal structure visible. Referring to FIG. 1 and FIG. 2, the transparent display apparatus 10 includes a transparent substrate 110, a pixel array 120, and a circuit structure 130. The circuit structure 130 includes multiple signal lines 132 and 134, and is substantially opaque to light. The transparent substrate 110 includes multiple display areas 10a and multiple transparent areas 10b. In some embodiments, the multiple transparent areas 10b may include multiple areas of the transparent substrate 110 that are not occupied by the circuit structure 130, while the multiple display areas 10a may be multiple areas of the transparent substrate 110 that are occupied by the circuit structure 130. For example, in some embodiments, in a top view of the transparent display apparatus 10, the circuit structure 130 generally forms a mesh structure. The mesh structure includes multiple longitudinal parts 130-1 and multiple lateral parts 130-2 that intersect each other. The multiple display areas 10a may respectively correspond to multiple intersection points of the multiple longitudinal parts 130-1 and the multiple lateral parts 130-2, and the multiple transparent areas 10b may correspond to multiple openings of the mesh structure, but the disclosure is not limited thereto. In some embodiments, the material of the transparent substrate 110 may be glass, quartz, organic polymer, or other suitable materials, but the disclosure is not limited thereto.

The pixel array 120 is disposed on the transparent substrate 110. The pixel array 120 includes multiple pixels 122 and multiple openings 124. The multiple pixels 122 are arranged in an array along a first direction x and a second direction y, wherein the first direction x and the second direction y intersect each other. For example, in some embodiments, the first direction x and the second direction y may be perpendicular to each other, but the disclosure is not limited thereto. Each pixel 122 overlaps with a corresponding display area 10a in a vertical direction z, wherein the first direction x and the second direction y are parallel to the transparent substrate 110, and the vertical direction z is perpendicular to the first direction x and the second direction y. Each opening 124 is surrounded by a portion of the multiple pixels 122, and each opening 124 overlaps with a corresponding transparent area 10b in the vertical direction z. For example, in some embodiments, each opening 124 may be a closed opening, but the disclosure is not limited thereto.

In some embodiments, each pixel 122 may include multiple sub-pixels 122r, 122g, and 122b that respectively emit a first colored light, a second colored light, and a third colored light. For example, in some embodiments, the first colored light, the second colored light, and the third colored light may respectively be a red light, a green light, and a blue light, but the disclosure is not limited thereto.

The multiple signal lines 132 and 134 of the circuit structure 130 are disposed on the transparent substrate 110, and are electrically connected to the multiple pixels 122. The signal lines 132 and 134 may be any conductive wires used to drive the pixels 122. Specifically, in some embodiments, the circuit structure 130 further includes multiple pixel driving circuits (not shown). Each pixel 122 includes a light-emitting element 122a, and the light-emitting element 122a of each pixel 122 is electrically connected to a corresponding pixel driving circuit. For example, in some embodiments, the pixel driving circuit may include a first transistor (not shown), a second transistor (not shown), and a capacitor (not shown). The second terminal of the first transistor is electrically connected to the control terminal of the second transistor. The capacitor is electrically connected to the second terminal of the first transistor and the first terminal of the second transistor. The first electrode (not shown) of the light-emitting element 122a is electrically connected to the second terminal of the second transistor. The multiple signal lines 132 and 134 may include a data line electrically connected to the first terminal of the first transistor, a scan line electrically connected to the control terminal of the first transistor, and a power line electrically connected to the first terminal of the second transistor. In some embodiments, the light-emitting element 122a is, for example, a light-emitting diode element, but the disclosure is not limited thereto.

In some embodiments, the signal lines 132 and 134 may include multiple first signal lines 132 extending substantially along the second direction y and multiple second signal lines 134 extending substantially along the first direction x. The longitudinal parts 130-1 and the lateral parts 130-2 of the circuit structure 130 may respectively include the first signal lines 132 and the second signal lines 134. The first signal lines 132 and the second signal lines 134 may be straight conductive wires or curved conductive wires. The first signal lines 132 and the second signal lines 134 may be formed by the same or different patterned conductive layers. The first signal lines 132 and the second signal lines 134 may be signal lines with a single-layer structure or signal lines with a multi-layer stacked structure. The material of the first signal lines 132 and the second signal lines 134 is preferably an opaque conductive material (for example, metal), but the disclosure is not limited thereto. In some embodiments, one of the first signal line 132 and the second signal line 134 is, for example, a data line, and the other of the first signal line 132 and the second signal line 134 is, for example, a scan line and/or a power line, but the disclosure is not limited thereto.

In some embodiments, the transparent display apparatus 10 may further include a transparent encapsulation element 140 (shown in FIG. 1). The transparent encapsulation element 140 is disposed on the first side S1 of the transparent substrate 110, and covers the multiple pixels 122. The transparent substrate 110, the circuit structure 130, the pixel array 120, and the transparent encapsulation element 140 may be considered as a display panel DP. The display panel DP has a display surface 10f and a back surface 10r. In some embodiments, the display surface 10f may be a surface of the transparent encapsulation element 140, and the back surface 10r may be a surface of the transparent substrate 110 facing away from the pixel array 120. In some embodiments, the transparent encapsulation element 140 may include a transparent encapsulation adhesive and/or a transparent cover plate, but the disclosure is not limited thereto.

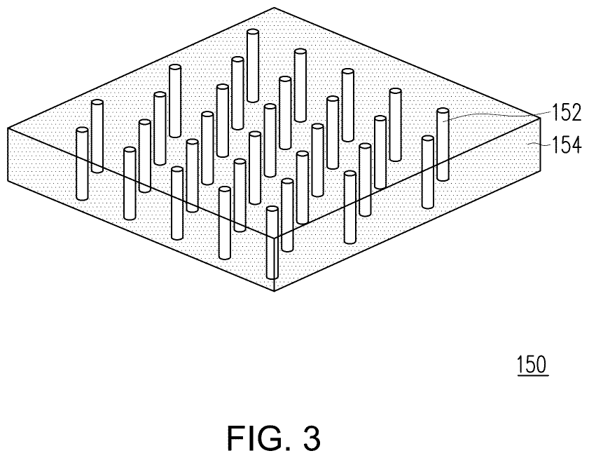

FIG. 3 is a perspective view showing the first light modulating element according to an embodiment of the disclosure. Referring to FIG. 1, FIG. 2, and FIG. 3, the transparent display apparatus 10 further includes a first light modulating element 150. The transparent substrate 110 has a first side S1 and a second side S2 opposite to each other. The multiple pixels 122 are disposed on the first side S1 of the transparent substrate 110. The first light modulating element 150 is disposed on the first side S1 of the transparent substrate 110. The multiple pixels 122 are located between the first light modulating element 150 and the transparent substrate 110. In some embodiments, the first light modulating element 150 is disposed on the transparent encapsulation element 140, wherein the transparent encapsulation element 140 is located between the first light modulating element 150 and the multiple pixels 122.

The first light modulating element 150 includes a first light modulating base 154 and multiple first light modulating pillars 152. The first light modulating base 154 has multiple light-absorbing particles and multiple openings 154a. Each first light modulating pillar 152 allows a light beam to pass through. That is, each first light modulating pillar 152 is a light-transmitting pillar. The multiple first light modulating pillars 152 are separated from each other, and are respectively disposed in the multiple openings 154a of the first light modulating base 154. For example, in some embodiments, the first light modulating base 154 includes plain glass and multiple light-absorbing particles doped into the plain glass, and the first light modulating base 154 may be gray glass, but the disclosure is not limited thereto. In some embodiments, the multiple openings 154a may be multiple through holes penetrating the first light modulating base 154, but the disclosure is not limited thereto. In some embodiments, the first light modulating pillar 152 may be a transparent adhesive filled into the opening 154a and cured.

Referring to FIG. 1, the first light modulating pillars 152 and the first light modulating base 154 have a refractive index difference Δn, wherein the refractive index difference Δn equals the refractive index of the first light modulating pillar 152 minus the refractive index of the first light modulating base 154. The first light modulating element 150 formed by the first light modulating pillars 152 and the first light modulating base 154 functions similarly to a grating, causing a light beam L from the pixel 122 to be diffracted and deflected at a large angle. Thus, the light beam L is reflected at a larger angle at an interface I between the first light modulating element 150 and the ambient medium (for example, air). The light beam L reflected at a larger angle can travel a longer distance within the first light modulating element 150, increasing the amount absorbed by the first light modulating element 150 and thereby improving halation and/or edge leakage of the transparent display apparatus 10. In addition, the light-transmitting first light modulating pillars 152 also help to improve the transmittance of the transparent display apparatus 10, providing favorable transparency effects.

Referring to FIG. 1 and FIG. 2, in some embodiments, the multiple first light modulating pillars 152 are arranged with equal spacings at a first spacing Λ₁ along a first arrangement direction r1 parallel to the transparent substrate 110. In some embodiments, by appropriately designing the size of the first spacing Λ₁, the first light modulating element 150 may have a small initial suppression angle and a wide suppression range. Specifically, the light beam L follows the formula:

$${n}_{t} sin {θ}_{m} = {n}_{i} sin {θ}_{i} + m \frac{λ}{{Λ}_{1}} ,$$

where nₜ is the refractive index of the ambient medium, θₘ is the exit angle, nᵢ is the refractive index of the first light modulating element 150, θᵢ is the incident angle, m is the diffraction coefficient, and λ is the wavelength of the light beam L. By substituting the exit angle θₘ=90° (that is, to maximize the deflection angle of the light beam L so as to travel the longest distance in the first light modulating element 150), the refractive index nₜ of the ambient medium (for example, air) nₜ=1, the refractive index nᵢ of the first light modulating element 150 nᵢ=1.5, the wavelength λ of the light beam L λ=550 nm, 25°<θᵢ<θ_{TIR} (that is, the target range of the incident angle θᵢ of the light beam L to be suppressed is greater than 25° and less than the total reflection angle) into the above formula, it can be obtained that 1.5 μm<Λ₁<∞. That is to say, in some embodiments, the first spacing Λ₁ of the multiple first light modulating pillars 152 is greater than 1.5 μm, which may improve the suppression effects of the first light modulating element 150, but the disclosure is not limited thereto.

Referring to FIG. 2, in some embodiments, the multiple first light modulating pillars 152 are arranged with equal spacings at the first spacing Λ₁ along the first arrangement direction r1 parallel to the transparent substrate 110, and the multiple first light modulating pillars 152 are arranged with equal spacings at a second spacing Λ₂ along a second arrangement direction r2 parallel to the transparent substrate 110. The first arrangement direction r1 and the second arrangement direction r2 intersect each other. That is to say, the first light modulating element 150 has a two-dimensional perforated grating structure, which may produce suppression effects in multiple azimuthal angles.

In some embodiments, the multiple first light modulating pillars 152 are further arranged with equal spacings at a third spacing Λ₃ along a third arrangement direction r3 parallel to the transparent substrate 110. The first arrangement direction r1, the second arrangement direction r2, and the third arrangement direction r3 intersect each other, and are not perpendicular to each other. The first spacing Λ₁, the second spacing Λ₂, and the third spacing Λ₃ may be substantially equal. For example, in some embodiments, an angle α between the first arrangement direction r1 and the second arrangement direction r2 may be 60°, and an angle β between the first arrangement direction r1 and the third arrangement direction r3 may be 120°, but the disclosure is not limited thereto.

Referring to FIG. 2, in some embodiments, multiple light modulating units U include the multiple first light modulating pillars 152. Each light modulating unit U includes seven first light modulating pillars 152 of the multiple first light modulating pillars 152, and the seven first light modulating pillars 152 include a first central light modulating pillar 152-1 and six first peripheral light modulating pillars 152-2; in a top view of the transparent display apparatus 10, the first central light modulating pillar 152-1 is disposed at a geometric center HXc of a quasi-hexagon HX, and the multiple first peripheral light modulating pillars 152-2 are respectively disposed at multiple vertices HXp of the quasi-hexagon HX.

Furthermore, in some embodiments, the multiple light modulating units U include a first light modulating unit U1 and a second light modulating unit U2 adjacent to each other. The first light modulating unit U1 and the second light modulating unit U2 share two first peripheral light modulating pillars 152-2 of the six first peripheral light modulating pillars 152-2 located on the same quasi-hexagon HX, and the two first peripheral light modulating pillars 152-2 are located on the same edge HXe of the same quasi-hexagon HX. That is to say, two edges HXe of multiple quasi-hexagons HX of any two adjacent light modulating units U may overlap with each other, and the multiple light modulating units U are arranged in the most compact manner.

It should be noted that the following embodiments continue to use the reference numerals and partial content of the aforementioned embodiments, wherein the same reference numerals are used to represent the same or similar components, and repeated descriptions will be omitted. Please refer to the aforementioned embodiments for the omitted parts, which will not be repeated in the following embodiments.

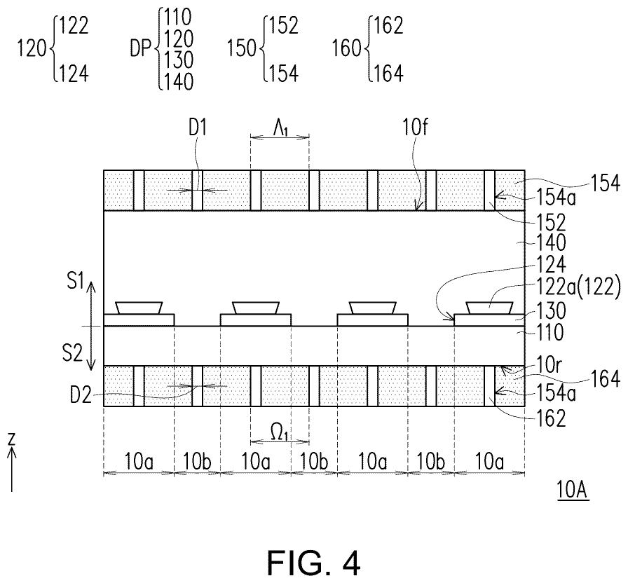

FIG. 4 is a cross-sectional view showing a transparent display apparatus 10A according to the second embodiment of the disclosure. The transparent display apparatus 10A of the second embodiment in FIG. 4 is similar to the transparent display apparatus 10 of the aforementioned first embodiment, with the difference being that: in addition to the first light modulating element 150, the transparent display apparatus 10A in FIG. 4 further includes a second light modulating element 160. The setting of the second light modulating element 160 helps to suppress back light leakage.

Referring to FIG. 4, the second light modulating element 160 is disposed on the second side S2 of the transparent substrate 110. The transparent substrate 110 is located between the multiple pixels 122 and the second light modulating element 160. The second light modulating element 160 is disposed on the back surface 10r of the display panel DP. The second light modulating element 160 includes a second light modulating base 164 and multiple second light modulating pillars 162. The second light modulating pillars 162 and the second light modulating base 164 have a refractive index difference. The second light modulating base 164 includes multiple light-absorbing particles and multiple openings 164a. Each second light modulating pillar 162 allows a light beam to pass through. That is, each second light modulating pillar 162 is a light-transmitting pillar. The multiple second light modulating pillars 162 are separated from each other, and are respectively disposed in the multiple openings 164a of the second light modulating base 164. For example, in some embodiments, the second light modulating base 164 includes plain glass and multiple light-absorbing particles doped into the plain glass, and the second light modulating base 164 may be gray glass, but the disclosure is not limited thereto. In some embodiments, the multiple openings 164a may be multiple through holes penetrating the second light modulating base 164, but the disclosure is not limited thereto. In some embodiments, the second light modulating pillar 162 may be a transparent adhesive filled into the opening 164a and cured, but the disclosure is not limited thereto. In some embodiments, the multiple first light modulating pillars 152 are substantially aligned with the multiple second light modulating pillars 162 respectively in the vertical direction z perpendicular to the transparent substrate 110, but the disclosure is not limited thereto.

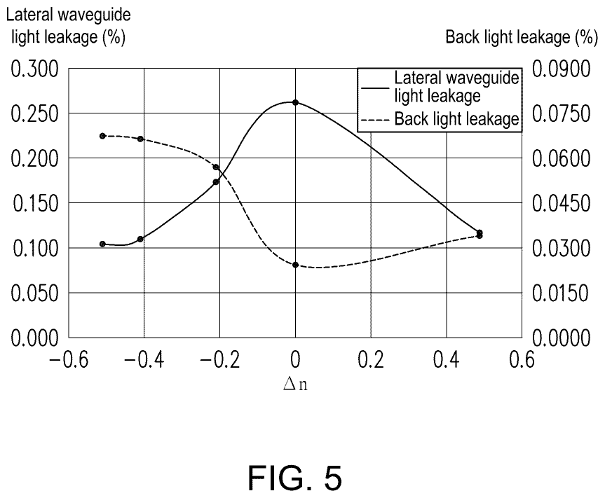

FIG. 5 shows the relationship between the refractive index difference Δn and lateral waveguide light leakage, as well as the relationship between the refractive index difference Δn and back light leakage in the transparent display apparatus 10A of the second embodiment of the disclosure. Referring to FIG. 4 and FIG. 5, in some embodiments, preferably the refractive index difference Δn>0. When the refractive index difference Δn>0, both lateral waveguide light leakage and back light leakage are suppressed. In some embodiments, the refractive index difference Δn may, for example, fall in a range of −0.5 to 0.5. In some embodiments, preferably 0<Δn≤0.5. In an optimal embodiment, the refractive index of the first light modulating pillar 152/the refractive index of the second light modulating pillar 162=2, the diameter D1 of the first light modulating pillar 152/the diameter D2 of the second light modulating pillar 162=10 μm, the spacing Λ₁ of the first light modulating pillar 152/the spacing Ω₁ of the second light modulating pillar 162=20 μm, and the transmittance of the first light modulating element 150/the second light modulating element 160 is 85%, but the disclosure is not limited thereto.

Table 1 lists various data for the transparent display apparatus of a comparative example (not shown), the transparent display apparatus 10 of the first embodiment, and the transparent display apparatus 10A of the second embodiment. The transparent display apparatus of the comparative example (not shown) is similar to the transparent display apparatus 10 of the first embodiment, with the difference being that: the transparent display apparatus of the comparative example does not include the first light modulating element 150 of the transparent display apparatus 10 of the first embodiment, but includes a whole piece of gray glass. That is to say, the transparent display apparatus of the comparative example is formed by replacing the first light modulating element 150 of the transparent display apparatus 10 of the first embodiment with a whole piece of gray glass.

Referring to Table 1, the data in Table 1 shows that, compared to the transparent display apparatus of the comparative example, the first light modulating element 150 significantly reduces the lateral waveguide intensity of the transparent display apparatus 10 of the first embodiment, thereby greatly improving edge leakage. In addition, the transmittance of the transparent display apparatus 10 of the first embodiment is slightly improved, and the back light leakage intensity of the transparent display apparatus 10 of the first embodiment is still within an acceptable range. Compared to the transparent display apparatus 10 of the first embodiment, the transparent display apparatus 10A of the second embodiment, through the first light modulating element 150 and the second light modulating element 160, not only reduces the lateral waveguide intensity and slightly improves the transmittance, but also more effectively suppresses back light leakage.

TABLE 1

| | Transparent display | | |
|---|---|---|---|
| | apparatus of the | Transparent display | Transparent display |
| | comparative | apparatus 10 of the | apparatus 10A of the |
| | example | first embodiment | second embodiment |
| Refractive index of | 1.51 | — | — |
| gray glass | | | |
| Refractive index of | — | 1.51 | 1.51 |
| the first light | | | |
| modulating base 154 | | | |
| Refractive index of | — | — | 1.51 |
| the second light | | | |
| modulating base 164 | | | |
| Refractive index of | — | 2 | 2 |
| the first light | | | |
| modulating pillar | | | |
| 152 | | | |
| Refractive index of | — | — | 2 |
| the second light | | | |
| modulating pillar | | | |
| 162 | | | |
| Spacing Λ₁ of the | — | 200 | 200 |
| first light modulating | | | |
| pillar 152 (μm) | | | |
| Spacing Ω₁ of the | — | — | 200 |
| second light | | | |
| modulating pillar | | | |
| 162 (μm) | | | |
| Diameter D1 of the | — | 100 | 100 |
| first light modulating | | | |
| pillar 152 (μm) | | | |
| Diameter D2 of the | — | — | 100 |
| second light | | | |
| modulating pillar | | | |
| 162 (μm) | | | |
| Transmittance (%) | 85.00 | 85.44 | 85.44 |
| Lateral waveguide | 0.229 | 0.130 | 0.116 |
| intensity | | | |
| Back light leakage | 2.192E−2 | 4.076E−2 | 3.372E−2 |
| intensity | | | |

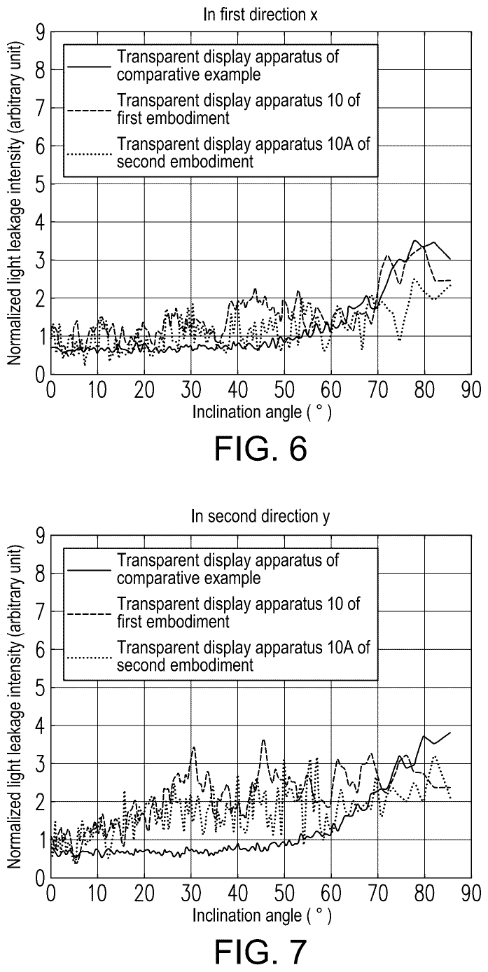

FIG. 6 shows the normalized light leakage intensity at various inclination angles in the first direction x with respect to the transparent display apparatus of a comparative example (not shown), the transparent display apparatus 10 of the first embodiment, and the transparent display apparatus 10A of the second embodiment. FIG. 7 shows the normalized light leakage intensity at various inclination angles in the second direction y with respect to the transparent display apparatus of the comparative example (not shown), the transparent display apparatus 10 of the first embodiment, and the transparent display apparatus 10A of the second embodiment. From FIG. 6 and FIG. 7, it can be seen that, compared to the transparent display apparatus of the comparative example, the light leakage of both the transparent display apparatus 10 of the first embodiment and the transparent display apparatus 10A of the second embodiment is suppressed.

What is claimed is:

1. A transparent display apparatus, comprising:
a transparent substrate comprising a plurality of display areas and a plurality of transparent areas;
a pixel array disposed on the transparent substrate, wherein the pixel array comprises:
a plurality of pixels arranged in an array along a first direction and a second direction, wherein the first direction and the second direction intersect each other, and each of the pixels overlaps with a corresponding one of the display areas; and
a plurality of openings, wherein each of the openings is surrounded by a portion of the pixels, and each of the openings overlaps with a corresponding one of the transparent areas;
a plurality of signal lines disposed on the transparent substrate, and electrically connected to the pixels; and
a first light modulating element, wherein the transparent substrate has a first side and a second side opposite to each other, the pixels are disposed on the first side of the transparent substrate, the first light modulating element is disposed on the first side of the transparent substrate, the pixels are located between the first light modulating element and the transparent substrate, and the first light modulating element comprises:
a first light modulating base comprising a plurality of light-absorbing particles and a plurality of openings; and
a plurality of first light modulating pillars separated from each other, wherein each of the first light modulating pillars allows a light beam to pass through, the first light modulating pillars are respectively disposed in the openings of the first light modulating base, and the first light modulating pillars and the first light modulating base have a refractive index difference.

2. The transparent display apparatus as claimed in claim 1, wherein the refractive index difference equals a refractive index of the first light modulating pillar minus a refractive index of the first light modulating base, and the refractive index difference is greater than 0.

3. The transparent display apparatus as claimed in claim 1, wherein the refractive index difference equals a refractive index of the first light modulating pillar minus a refractive index of the first light modulating base, and the refractive index difference falls in a range of −0.5 to 0.5.

4. The transparent display apparatus as claimed in claim 1, wherein the refractive index difference equals a refractive index of the first light modulating pillar minus a refractive index of the first light modulating base, and the refractive index difference is greater than 0 and less than or equal to 0.5.

5. The transparent display apparatus as claimed in claim 1, wherein the openings are a plurality of through holes penetrating the first light modulating base.

6. The transparent display apparatus as claimed in claim 1, wherein a plurality of light modulating units comprise the first light modulating pillars, each of the light modulating units comprises seven first light modulating pillars of the first light modulating pillars, and the seven first light modulating pillars comprise a first central light modulating pillar and six first peripheral light modulating pillars; in a top view of the transparent display apparatus, the first central light modulating pillar is disposed at a geometric center of a quasi-hexagon, and the first peripheral light modulating pillars are respectively disposed at a plurality of vertices of the quasi-hexagon.

7. The transparent display apparatus as claimed in claim 6, wherein the light modulating units comprise a first light modulating unit and a second light modulating unit adjacent to each other, the first light modulating unit and the second light modulating unit share two first peripheral light modulating pillars of the six first peripheral light modulating pillars, and the two first peripheral light modulating pillars are located on a same side of the quasi-hexagon.

8. The transparent display apparatus as claimed in claim 1, wherein the first light modulating pillars are arranged with equal spacings at a first spacing in a first arrangement direction parallel to the transparent substrate, the first light modulating pillars are arranged with equal spacings at a second spacing in a second arrangement direction parallel to the transparent substrate, the first light modulating pillars are arranged with equal spacings at a third spacing in a third arrangement direction parallel to the transparent substrate; the first arrangement direction, the second arrangement direction, and the third arrangement direction intersect each other and are not perpendicular to each other, and the first spacing, the second spacing, and the third spacing are substantially equal.

9. The transparent display apparatus as claimed in claim 1, wherein the first light modulating pillars are arranged with equal spacings at a first spacing in a first arrangement direction parallel to the transparent substrate, the first spacing is Λ₁, and 1.5 μm<Λ₁.

10. The transparent display apparatus as claimed in claim 1, further comprising:
a second light modulating element, wherein the second light modulating element is disposed on the second side of the transparent substrate, the transparent substrate is located between the pixels and the second light modulating element, and the second light modulating element comprises:
a second light modulating base comprising a plurality of second light-absorbing particles and a plurality of openings; and
a plurality of second light modulating pillars separated from each other, wherein each of the second light modulating pillars allows a light beam to pass through, the second light modulating pillars are respectively disposed in the openings of the second light modulating base, and the second light modulating pillars and the second light modulating base have a refractive index difference.

11. The transparent display apparatus as claimed in claim 10, wherein the first light modulating pillars are substantially aligned with the second light modulating pillars respectively in a vertical direction perpendicular to the transparent substrate.

12. A transparent display apparatus, comprising:
a transparent substrate comprising a plurality of display areas and a plurality of transparent areas;
a pixel array disposed on the transparent substrate, wherein the pixel array comprises:
a plurality of pixels arranged in an array, and each of the pixels overlaps with a corresponding one of the display areas; and
a plurality of openings, wherein each of the openings is surrounded by a portion of the pixels, and each of the openings overlaps with a corresponding one of the transparent areas;
a plurality of signal lines disposed on the transparent substrate, and electrically connected to the pixels; and
a first light modulating element, wherein the transparent substrate has a first side and a second side opposite to each other, the pixels are disposed on the first side of the transparent substrate, the first light modulating element is disposed on the first side of the transparent substrate, the pixels are located between the first light modulating element and the transparent substrate, and the first light modulating element comprises:
a first light modulating base having a plurality of openings; and
a plurality of first light modulating pillars separated from each other, wherein the first light modulating pillars are respectively disposed in the openings of the first light modulating base;
wherein a plurality of light modulating units comprise the first light modulating pillars, each of the light modulating units comprises seven first light modulating pillars of the first light modulating pillars, and the seven first light modulating pillars comprise a first central light modulating pillar and six first peripheral light modulating pillars; in a top view of the transparent display apparatus, the first central light modulating pillar is disposed at a geometric center of a quasi-hexagon, and the first peripheral light modulating pillars are respectively disposed at a plurality of vertices of the quasi-hexagon.

13. The transparent display apparatus as claimed in claim 12, wherein the first light modulating pillars and the first light modulating base have a refractive index difference, the refractive index difference equals a refractive index of the first light modulating pillar minus a refractive index of the first light modulating base, and the refractive index difference is greater than 0.

14. The transparent display apparatus as claimed in claim 12, wherein the first light modulating pillars and the first light modulating base have a refractive index difference, the refractive index difference equals a refractive index of the first light modulating pillar minus a refractive index of the first light modulating base, and the refractive index difference falls in a range of −0.5 to 0.5.

15. The transparent display apparatus as claimed in claim 12, wherein the first light modulating pillars and the first light modulating base have a refractive index difference, the refractive index difference equals a refractive index of the first light modulating pillar minus a refractive index of the first light modulating base, and the refractive index difference is greater than 0 and less than or equal to 0.5.

16. The transparent display apparatus as claimed in claim 12, wherein the openings are a plurality of through holes penetrating the first light modulating base.

17. The transparent display apparatus as claimed in claim 12, wherein the light modulating units comprise a first light modulating unit and a second light modulating unit adjacent to each other, the first light modulating unit and the second light modulating unit share two first peripheral light modulating pillars of the six first peripheral light modulating pillars, and the two first peripheral light modulating pillars are located on a same side of the quasi-hexagon.
